(19) United States
(12) Patent Application Publication
(10) Pub. No.: US 2014/0344684 A1
(43) Pub. Date: Nov. 20, 2014

(54) SYSTEM FOR GENERATING UNIQUE HANDWRITING STYLE OF USER AND METHOD THEREFOR

(71) Applicant: Kyung Ho JANG, Seoul (KR)

(72) Inventor: Kyung Ho Jang, Seoul (KR)

(73) Assignee: KYUNG HO JANG, Seoul (KR)

(21) Appl. No.: 14/361,241

(22) PCT Filed: Nov. 28, 2012
(86) PCT No.: PCT/KR2012/010196

§ 371 Date: May 28, 2014

(30) Foreign Application Priority Data
Nov. 28, 2011 (KR) 10-2011-0124954

(51) Int. Cl. G06F 3/0488; G06F 17/28; G06F 17/27

(52) U.S. Cl. CPC G06F 3/04883; G06F 17/277; G06F 17/28
USPC 715/709

(57) ABSTRACT

Provided is a system for generating a unique handwriting style of a user in which a minimum amount of phonemes, for example, only 59 phonemes of Hangul, are received from a user and transformed and combined to implement a syllable, thus simply generating a unique handwriting of a user. According to the system, a phoneme input by a user is displayed on a display screen of a smartphone, or the like, and corresponding phonemes are received based on the displayed input phoneme, thus implementing a handwriting fitting a user handwriting, and when a syllable is formed with a plurality of phonemes, a syllable is implemented by matching a designated connection point to each phoneme, thereby generating a natural handwriting.

### TECHNICAL FIELD

The present invention relates to a system for generating a unique handwriting style of a user and a method therefor, and more particularly, to a system for generating a unique handwriting style of a user capable of receiving a minimum input phoneme from a user, converting the received phoneme to generate a transformed phoneme, and subsequently combining the input phoneme and the transformed phoneme to implement full syllables, thus simply and quickly generating a handwriting unique to the user, and a method therefor.

### BACKGROUND ART

Systems for receiving a user's handwriting in advance and analyzing the received handwriting to automatically implement the user's handwriting in an environment such as in a personal computer (PC) or a personal mobile device is demonstrated in Korean Patent Registration Nos. 801224 and 933707. In these systems, a predetermined number of user's handwritings are received from a user, based on which the user's handwriting is automatically generated by the medium of a computer program and other applications.

Korean Patent Registration No. 933707 to the same applicant of the present disclosure, devised to improve a “System and Method For Generating User-specific Handwriting” of Korean Patent Registration No. 801224 to the same applicant of the present disclosure, supplements shortcomings of this document that a user's handwriting is uniform and stereotyped, by providing a handwriting combining system including a handwriting recognition module receiving a predetermined number of letters from a user and recognizing a distance between phonemes and syllables, shapes of phonemes and syllables, and positions of phonemes and syllables to recognize a user's handwriting. The handwriting combining system includes a point designating module designating a fragmented particular position within each phoneme of a user's handwriting recognized by the handwriting recognition module; a reference point setting module setting a reference point as a reference with respect to a change in a phoneme and a syllable in a position within or outside of a phoneme or a syllable of the user recognized by the handwriting recognition module; and a handwriting transforming module designating x and y-axis coordinate values with respect to a first point from the reference point and setting coordinate values of points following the first point based on x and y-axis distances with respect to immediately previous points to thus set relative coordinate values with respect to respective points, and subsequently changing a relative coordinate value of a particular point or a particular phoneme or syllable to transform a position of a handwriting, a distance between handwritings, and a shape of a handwriting.

However, the foregoing technique is implemented upon receiving 190-letter syllables, causing user inconvenience in inputting syllables.

Thus, a new and advanced user-specific handwriting generating system that may be able to achieve a maximum of handwriting implementation efficiency with minimum effort by minimizing user inconvenience by using a method of receiving data in units of phonemes, rather than syllables, from a user is required.

### DISCLOSURE

### Technical Problem

Therefore, an object of the present invention is to simply generate a unique handwriting style of a user by receiving only 59 phonemes from the user and transforming and combining the received phonemes to thus implement a full Hangul syllable.

Another object of the present invention is to display phonemes input by a user and selectively receive corresponding phonemes based on the displayed phonemes, thus implementing a handwriting conforming to a user's handwriting.

Another object of the present invention is to implement syllables such that connection points are matched to respective phonemes in forming syllables with a plurality of phonemes, thus generating a more natural handwriting.

Another object of the present invention is to calculate the area of a region of a handwriting input by a user and differentially transforming phonemes based on the calculated width of the region of the handwriting, thus stably generating various types of transformed phonemes.

Another object of the present invention is to supplement an insufficient handwriting combining scheme by combining final consonants based on final constant position values.

Another object of the present invention is to combine two or more input phonemes as generated to thus implement a handwriting, thus allowing a user to visually recognize syllables formed as phonemes input by the user himself or herself are combined in real time, thus enhancing user satisfaction.

### Technical Solution

In one general aspect, a system for generating a unique handwriting style of a user includes: a region designating module configured to classify divided regions of a screen into a guide region guiding a user input and an input region receiving handwriting data from a user; an input module including a guide unit configured to display phoneme samples guiding a handwriting input of the user in the guide region and an input phoneme generating unit configured to receive a unique handwriting style of a user from the user with the phoneme samples displayed in the guide unit, and store the same as input phonemes; a transforming module configured to generate various types of transformed phoneme according to different sizes and positions of respective input phonemes, and classify and store the generated transformed phonemes; and a handwriting combining module configured to combine the input phonemes and the transformed phonemes to implement a unique handwriting style of the user.

### Advantageous Effects

The user-specific handwriting generating system according to the present invention has the following advantages.

1) Only 59 phonemes are received from a user and transformed and combined to implement full Hangul syllables, thus simply generating a unique handwriting style of the user.

2) Phonemes input by a user are displayed, based on which corresponding phonemes are received, whereby a handwriting conforming to a user handwriting may be implemented.

3) In forming syllables with a plurality of phonemes, syllables are implemented by connecting connection points designated in respective phonemes, whereby more natural handwriting may be generated.

4) The area of a region of a handwriting input by a user is calculated, based on which phonemes are deformed to thus stably generate transformed phonemes.

5) When two or more input phonemes are generated, they are combined to implement an exemplary handwriting, whereby a user may visually recognize syllables formed as phonemes input by the user himself or herself are combined in real time, thus enhancing user satisfaction.

### DESCRIPTION OF DRAWINGS

FIG. 1 is a conceptual view illustrating a schematic principle and operation of a system for generating a unique handwriting style of a user according to an embodiment of the present invention.

FIG. 2 is a block diagram illustrating a configuration of the user-specific handwriting generating system according to an embodiment of the present invention.

FIG. 3 is a conceptual view illustrating an embodiment of an input module according to the present invention.

FIG. 4 is a conceptual view illustrating connection points according to the present invention.

FIG. 5 is a conceptual view illustrating a process of generating a transformed phoneme according to the present invention.

FIG. 6 is a flow chart illustrating a method for implementing a handwriting according to the present invention.

### BEST MODE

A system for generating a unique handwriting style of a user includes: a region designating module configured to classify divided regions of a screen into a guide region guiding a user input and an input region receiving handwriting data from a user; an input module including a guide unit configured to display phoneme samples guiding a handwriting input of the user in the guide region and an input phoneme generating unit configured to receive a unique handwriting style of a user from the user with the phoneme samples displayed in the guide unit, and store the same as input phonemes; a transforming module configured to generate various types of transformed phoneme according to different sizes and positions of respective input phonemes, and classify and store the generated transformed phonemes; and a handwriting combining module configured to combine the input phonemes and the transformed phonemes to implement a unique handwriting style of the user.

### MODE FOR INVENTION

Hereinafter, embodiments of the present invention will be described in detail with reference to the accompanying drawings. In drawings, the like reference numerals designate like elements.

A system for generating a unique handwriting style of a user may be installed in a personal computer (PC), a personal mobile device, and the like, as hardware, receive 59 phonemes having handwriting features unique to a user by the medium of a mouse, a tablet, a touch screen, and the like, from the user, transform the received input phonemes according to use purposes to generate transformed phonemes, and combines a total of 11,172 characters based on the generated transformed phonemes to thus generate a case of handwriting having handwriting features unique to the user.

Namely, data in units of phonemes, rather than, in units of letters, is received from the user, and a case of handwriting is implemented based on the received data, whereby a basic amount of data to be received from the user is minimized, promoting user convenience and more quickly and simply generating a unique handwriting style of the user, compared to an existing related art.

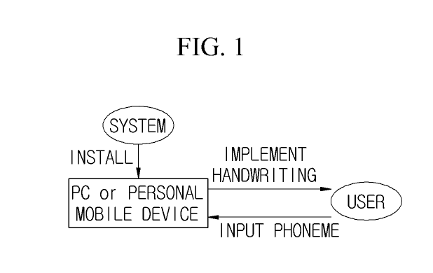

FIG. 1 is a conceptual view illustrating a schematic principle and operation of the user-specific handwriting generating system according to the present invention.

As can be seen in FIG. 1, the system according to the present invention displays phoneme samples and guide information, and the like, for providing information regarding input phonemes to be received from a user through a display unit 1 of a monitor, a screen, and the like, of a personal computer (PC), a personal mobile device in which the system is installed, receives input phonemes as a basic ground for implementing a user's handwriting by the medium of a mouse, a tablet, a touch screen, and the like, from the user who have checked the displayed phoneme samples and guide information, and stores, transforms, and combines the input phonemes to generate a unique handwriting style of the user.

In other words, as illustrated in FIG. 1, the system is installed in a PC, a mobile device, and the like, to communicate with a user through the display unit 1 such as a monitor, a screen, and the like, and is configured to receive input phonemes required for generating a handwriting from the user by the medium of an input unit such as a mouse, a tablet, a touch screen, and the like.

Prior to detailed descriptions of the configuration of the present invention, in order to receive only 59 phonemes from the user and express every syllable of Hangul based on the received phonemes, Hangul phonemes need to be classified in accordance with a predetermined reference, and in the present invention, and the system according to the present invention classifies Hangul phonemes based on a reference as shown in Table 1.

Obviously, the technical concept of the present invention may also be applied to languages other than Hangul.

TABLE 1

| Large | Middle | Small | Included |
|---|---|---|---|
| classification | classification | classification | phoneme |
| Open syllable | Ordinate-axis | First group | [symbol] , [symbol] , [symbol] , [symbol] , [symbol] , [symbol] , [symbol] , [symbol] , [symbol] |
| phoneme | vowel | vowel | |
| | Transverse-axis | Second group | [symbol] , [symbol] , [symbol] |
| | vowel | vowel | |
| | | Third group | [symbol] , [symbol] |
| | | vowel | |
| | Ordinate/ | Fourth group | [symbol] , [symbol] , [symbol] , [symbol] |
| | transverse- | vowel | |
| | axis vowel | Fifth group | [symbol] , [symbol] , [symbol] |
| | | vowel | |

Hangul vowels may be used in an open syllable and a closed syllable. Namely, the phonemes arranged in Table 1 are those used in syllables without a final consonant.

Also, 21 Hangul vowels may be classified based on an axis in the form of a vowel based on features that forms of consonants used together with corresponding vowels may be transformed according to vowels of each group. For example, it is based upon recognition that shapes of “ [symbol] ” used in “ [symbol] ” (first group vowel), “ [symbol] ” (second group vowel), “ [symbol] ” (third group vowel), “ [symbol] ” (fourth group vowel), and “ [symbol] ” (fifth group vowel) are different.

For example, referring to “ [symbol] ” of an existing “BatangChe”, “ [symbol] ” used together with a first group vowel has a shape of “ [symbol] ” in a left central portion based on a space of squared manuscript paper as a reference, and “ [symbol] ” forming a syllable together with a second group vowel is implemented as a shape of “ [symbol] ” in an upper central portion. Namely, although they are consonants, shapes thereof may be changed depending on types of vowel used together. “ [symbol] ” used together with a third group vowel has a shape similar to that of “ [symbol] ” used together with a second group vowel, but a shape, a size, and a position thereof may be changed according to features of a unique handwriting style of the user. This is no different in fourth group vowels and fifth group vowels

As for Hangul consonants, consonants used together with corresponding group vowels are classified into respective group consonants according to the classification of respective group vowels.

Namely, Hangul consonants are classified into first to fifth group consonants (consonants used in an open syllable) used together with the first to fifth vowels, respectively.

In this case, the respective group consonants refer to a set of 19 Hangul consonants including all of single components from “ [symbol] ” to “ [symbol] ” and “ [symbol] ”, “ [symbol] ”, “ [symbol] ”, “ [symbol] ”, and “ [symbol] ” and are defined on the premise that, although consonants are same type of consonants, shapes and positions of consonants used together with respective group vowels are different. Namely, as described above, shapes and positions of “ [symbol] ”, “ [symbol] ”, and “ [symbol] ” in “ [symbol] ”, “ [symbol] ”, and “ [symbol] ” (First group consonants used together with the first group vowels) and shapes and positions of “ [symbol] ”, “ [symbol] ”, and “ [symbol] ” in “ [symbol] ”, “ [symbol] ”, and “ [symbol] ” (second group consonants used together with the second group vowels) are different, and thus, a set of consonants used together with respective group vowels are classified as a group.

According to the features of the foregoing Hangul phonemes in terms of forms, phonemes required for implementing all the syllables of Hangul may vary in types and forms, and the vowels classified in Table 1 may be advantageously used in the description of a detailed configuration of the system according to the present invention.

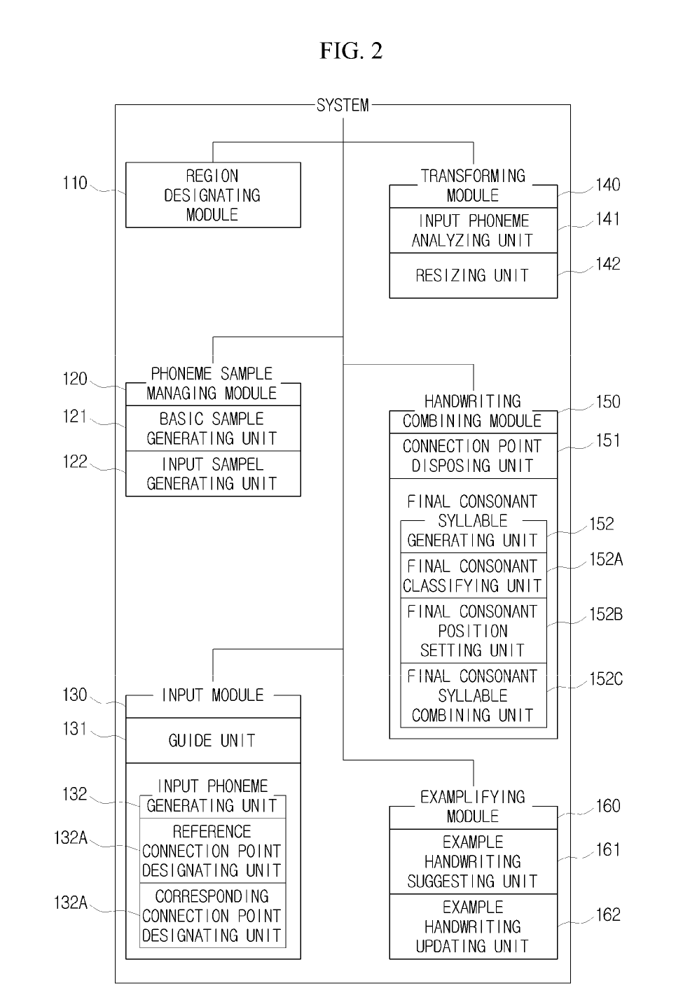

FIG. 2 is a block diagram illustrating a configuration of the user-specific handwriting generating system according to an embodiment of the present invention.

As illustrated in FIG. 2, the user-specific handwriting generating system according to the present invention basically includes a region designating module 110, an input module 130, a transforming module 140, and a handwriting combining module 150 and additionally includes a phoneme sample managing module 120 and an exemplifying module 160.

The region designating module 110 divides a screen into sections 2 and designates virtual regions. The region designating module 110 classifies the sections into a guide region guiding a user input and an input region receiving handwriting data from the user.

In this case, the section 2 refers to a section of the display unit 1, having a concept similar to a space of squared manuscript paper in which one syllable is written. The section 2 is a space in which the user recognizes a size of a unit of a syllable and inputs a phoneme having an appropriate size based on the section 2, whereby an input phoneme conforming to a unique handwriting style of the user.

Also, the section 2 is configured as a plane of coordinates to make an input handwriting data and is used to combine input handwritings according to a particular reference to assist the input module 130 and the handwriting combining module 150 in performing their function smoothly.

The guide region and the input region may be displayed in a stacked manner in the section 2 according to the region designating module 110, and in this case, the guide region is a region in which a phoneme sample to be described hereinafter is to be displayed and the input region is a region to which the user is guided by a phoneme sample displayed in the guide region to receive an input phoneme.

The reason for dividing the section 2 into the guide region and the input region is to distinguish between a region for displaying phoneme samples and a region for receiving a handwriting when input phonemes are received from the user by using the input module 130 as described hereinafter. The guide region and the input region may be spatially distinguished in the section 2 or may overlap according to circumstances. Namely, preferably, the respective regions are understood as virtual layers, rather than visual sections according to spatial separation.

In particular, the input region may be formed as a layer such that several input regions including different handwritings may be combined in a stacked manner by the handwriting combining module, and the like, as described hereinafter.

The input module 130 serves to receive 59 input phonemes from the user.

In this case, 59 input phonemes include first to fifth group vowels (21 vowels) a set of consonants (19 first group consonants) used together with the first group vowels, and a set of consonants (19 second group consonants) used together with the second group vowels. The first to fifth vowels may be received and neutral vowels in closed syllables in which only positions and sizes are different to a degree may be transformed to be implemented based on a corresponding handwriting. Accordingly, first to fifth vowels to be received from the user are defined as input vowels and neutral vowels generated by transforming the input vowels are defined as transformed vowels.

Also, when the shapes and positions of the second group consonants and the third to fifth group consonants are compared, basic shapes of the third to fifth consonants are similar to those of the second group consonants but sizes and positions thereof are transformed. Namely, referring to “ [symbol] ” (second group), “ [symbol] ” (third group), “ [symbol] ” (fourth group), “ [symbol] ” (fifth group), it can be seen that basic shapes of the second to fifth consonants are very similar, while the second group consonants and the third group consonants are different in lengths and the second group consonants and the fourth and fifth group consonants are different in sizes and positions.

Thus, when second group consonants are received from the user, sizes, positions, and the like, of the second group consonants may be transformed to generate consonants (third to fifth group consonants) used together with the third to fifth group vowels, and in a similar manner, the first to fifth group consonants may be transformed to generate an initial consonant in a closed syllable may be generated, and also, a final consonant (final consonant in a closed syllable) may also be transformed to be generated based on the second group consonants.

Based on the recognition that the first and second group consonants are essential consonants to be received from the user, which are used as standard data in generating transformed consonants, the first and second group consonants are defined as input consonants, and in this sense, the third to fifth consonants, initial consonants, and final consonants are defined as transformed consonants.

By generating transformed vowels and transformed consonants through the input vowels and input consonants, the system according to the present invention may generate every phoneme constituting Hangul syllables.

A process of transforming input phonemes as needed will be described in conjunction with the transforming module 140 hereinafter.

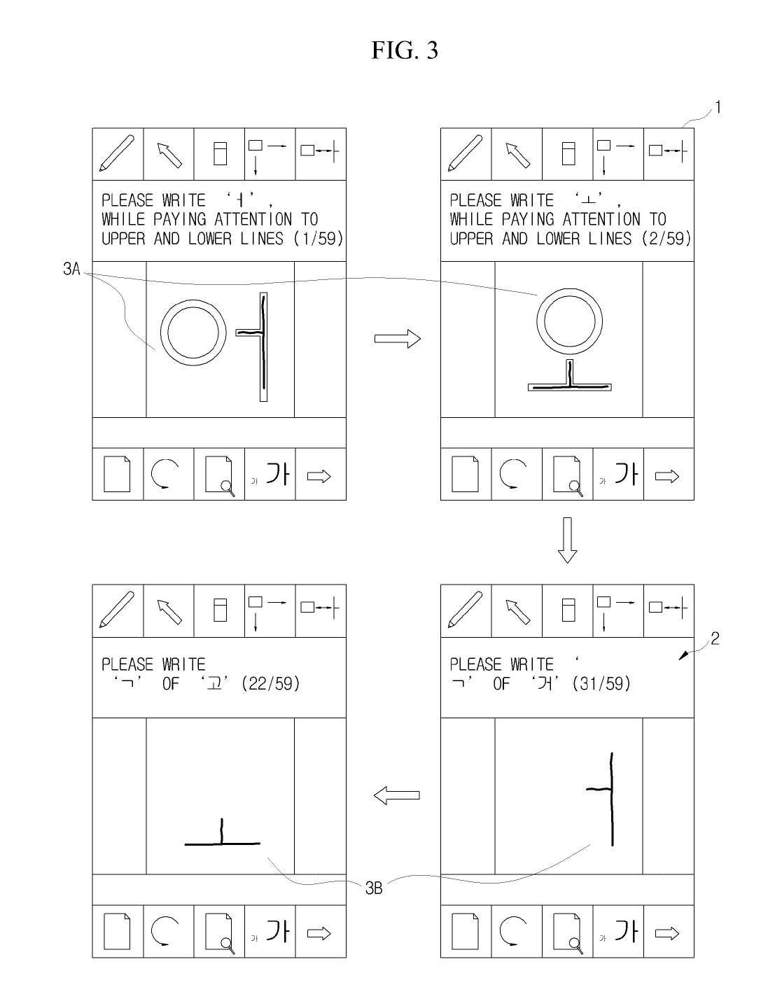

FIG. 3 is a conceptual view illustrating an embodiment of a process of inputting input phonemes according to the present invention.

The phoneme sample managing module 120 and the input module 130 will be described with reference to FIG. 3. The phoneme sample managing module 120 manages phoneme samples used by the input module 130. The phoneme samples include basic samples 3a each having a phoneme shape composed of a certain handwriting, rather than user's handwriting, an input sample 3b, one of input phonemes input by the user, and a transformed sample generated by the transforming module 140. Thus, the phoneme sample managing module 120 includes a basic sample generating unit 121 and an input sample generating unit 122.

The basic sample generating unit 121 generates the basic samples 3a by extracting at least one syllable from a previously stored font DB. The font DB is a database storing fonts according to any one handwriting among certain known handwritings such as BatangChe, GothicChe, and the like.

The basic samples 3a generated by the basic sample generating unit 121 are syllables (for example, “ [symbol] ” and “ [symbol] ”) composed of a first group vowel and a first group consonant or a second group vowel and a second group consonant shaped in dim lines as illustrated in FIG. 3. The basic samples 3a may be displayed in the guide region so that the user may input a first group vowel and a second group vowel (“ [symbol] ” and “ [symbol] ”) to the input region, and in this case, preferably, the guide region and the input region serve as layers.

With the basic samples 3a displayed, the user may input an input phoneme which has the same type as that of the basic samples 3a and follows a unique handwriting style of the user to an appropriate region.

The input sample generating unit 122 generates the input samples 3b by extracting at least one of the input phonemes. As for the input samples 3b, when an input phoneme and a transformed phoneme are generated by the input module 130 and the transforming module 140, one of them is selected as the input sample 3b and displayed, thereby guiding to receive another input phoneme.

In other words, as illustrated in FIG. 3, in a state in which any one (“ [symbol] ” or “ [symbol] ”) among input phonemes received through the basic samples 3a is displayed in the guide region, a phoneme forming a particular syllable together with the input sample 3b is received by the input region. Thereafter, any one of received input phonemes is generated as the input sample 3b (for example, “ [symbol] ” of “ [symbol] ”) and displayed, and thereafter, a phoneme forming a particular syllable together with the input sample 3b is received from the user. This process is repeatedly performed to receive 59 input phonemes.

Since the phoneme samples are composed of the basic sample 3a and the input same 3b, the system according to the present invention may minimize the number of basic samples 3a to be stored, and since the input sample 3b composed of any one of the input phonemes input by the user is displayed, a problem such as mismatch between respective phonemes, and the like, that may arise during a process of receiving phoneme units, rather than syllable units, may be simply solved.

An embodiment of the phoneme samples will be described in detail together with the input module 130.

The input module 130 includes a guide unit 131 and an input phoneme generating unit 132.

The guide unit 131 displays phoneme samples guiding a user input to the guide region by the medium of the display unit 1 of a PC or a personal mobile device. The phoneme samples may guide a position within the section 2 in which the user may input particular phonemes of his or her unique handwriting and allow the user to recognize in which shape an input phoneme is matched with a different phoneme.

The input phoneme generating unit 132 receives user-specific handwriting data from the user by the input region and stores the received user-specific handwriting data as an input phoneme to establish an input phoneme database (DB).

Namely, in a state in which a phoneme sample is displayed by the guide unit 131, user-specific handwriting data guided by a phoneme sample is received from the user. In this case, the input phoneme generating unit 132 and the guide unit 131 may need to organically serve to allow displaying of a phoneme sample (the guide unit 131) and generating of an input phoneme (the input phoneme generating unit 132) to be sequentially and repeatedly performed. Obviously, a process of receiving handwriting data, storing the received handwriting data as an input phoneme, and subsequently formatting handwriting data which has been immediately previously received may need to be included, which, however, is a known art so a detailed description thereof will be omitted.

Repeating this process, the basic sample 3a is first displayed and an input sample 3b is displayed next time, and in this order, all of 59 phonemes may be sequentially received from the user.

The input phoneme generating unit 132 generating an input phoneme through this process may designate a connection point in each input phoneme to allow the handwriting combining module 150 to easily combine respective phonemes to form a syllable. To this end, the input phoneme generating unit 132 may include a reference connection point designating unit 132a and a corresponding connection point designating unit 132b.

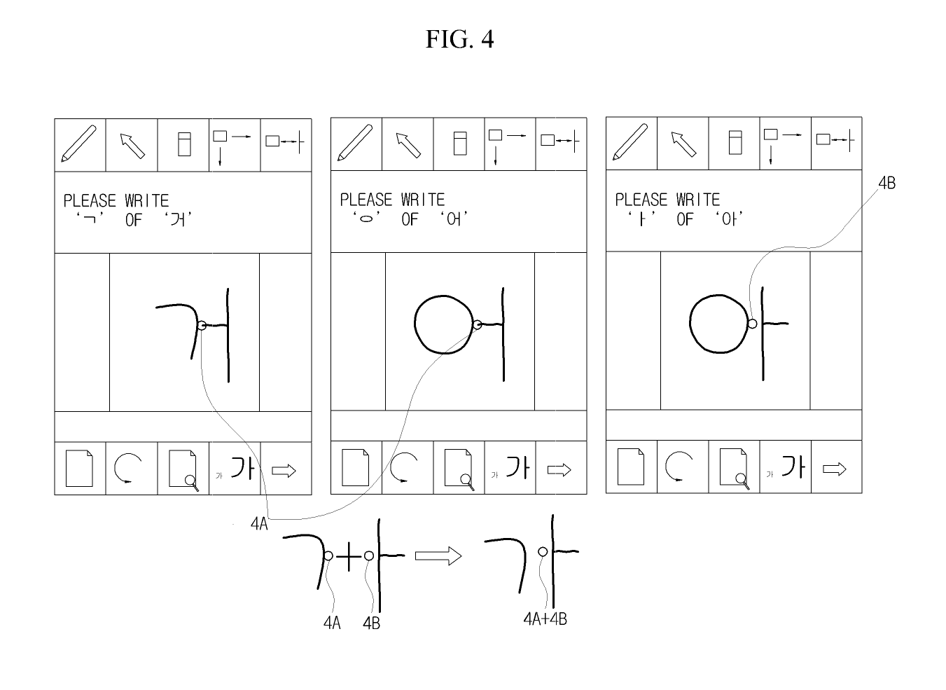

FIG. 4 is a conceptual view illustrating connection points according to the present invention.

A connection point will be described in detail with reference to FIG. 4. A connection point refers to a particular portion used as a reference in combining each input phoneme received from the user and a transformed phoneme generated based on each input phoneme to generate a syllable. Based on a connection point, the handwriting combining module 150 as described hereinafter combines respective phonemes in a point-to-point manner.

The reference connection designating unit 132a designates a reference connection point 4a in one end portion of the input sample 3b, and when the guide unit displays the input sample 3b with the reference connection point 4a designated therein, the corresponding connection point designating unit 132b designates a corresponding connection point 4b of the handwriting at a position identical to that the position where the reference connection point 4a is disposed and subsequently stores the corresponding handwriting and the corresponding connection point 4b as the input phoneme.

For a smooth operation, the reference connection designating unit 132a may additionally include a reference connection point coordinate value extracting unit. The connection point coordinate value extracting unit may recognize a position of the reference connection point in the section to generate a connection point coordinate value. In other words, the input sample 3b is in an input region (layer) in which the user's handwriting having a particular shape is included, and thus, when the reference connection point is designated in the corresponding input region, the corresponding point is substitute for a plane of coordinates of the section 2 to determine a coordinate value.

With the reference connection point coordinate value generated, when the guide unit displays the input sample with the connection point designated therein, the corresponding connection point designating unit 132 may designate the position of the connection point coordinate value as a corresponding connection point of the handwriting received from the user, thus simply designating the connection point.

Referring to the exemplary embodiment with reference to FIG. 4, the phoneme sample managing module 120 sets “ [symbol] ” (namely, any one of first group vowels) input in a state in which the basic same 3a is displayed, as an input sample 3b, and a connection point in a left end portion of “ [symbol] ” is designated and stored through the reference connection point designating unit 132a.

Thereafter, “ [symbol] ” (input sample 3b) with the connection point designated therein is displayed in the guide region and “ [symbol] ” of “ [symbol] ” is received in the input region from the user through the input module 130.

In this case, the corresponding connection point designating unit 132b designates the corresponding connection point 4b of “ [symbol] ” received in the position in which the reference connection point 4a of “ [symbol] ” is designated, and subsequently stores the same together with the received handwriting “ [symbol] ” as an input phoneme.

Thereafter, “ [symbol] ” (input sample 3b) is displayed in the guide region as illustrated in the drawing, “ [symbol] ” of “ [symbol] ” is received in the input region from the user and a corresponding connection point 4b is designated, “ [symbol] ” with the connection point designated therein is displayed as the input sample 3b, “ [symbol] ” of “ [symbol] ” or is received, and a connection point of “ [symbol] ” is subsequently designated in the position of the connection point of “ [symbol] ”.

Thereafter, when the handwriting combining module 150 combines “ [symbol] ” and “ [symbol] ” to form “ [symbol] ”, the two input regions including the connection point and the handwriting may be disposed in a stacked manner such that the connection point is overlapped in the same position to allow the respective phonemes to be combined, whereby numerous Hangul syllables may be generated.

The transforming module 140 differentiates sizes of respective input phonemes (resizes the respective input phonemes) to generate various types of transformed phonemes according to sizes of the input phonemes, and stores the same in a transformed phoneme DB. The transforming module 140 includes an input phoneme analyzing unit 141 and a resizing unit 142.

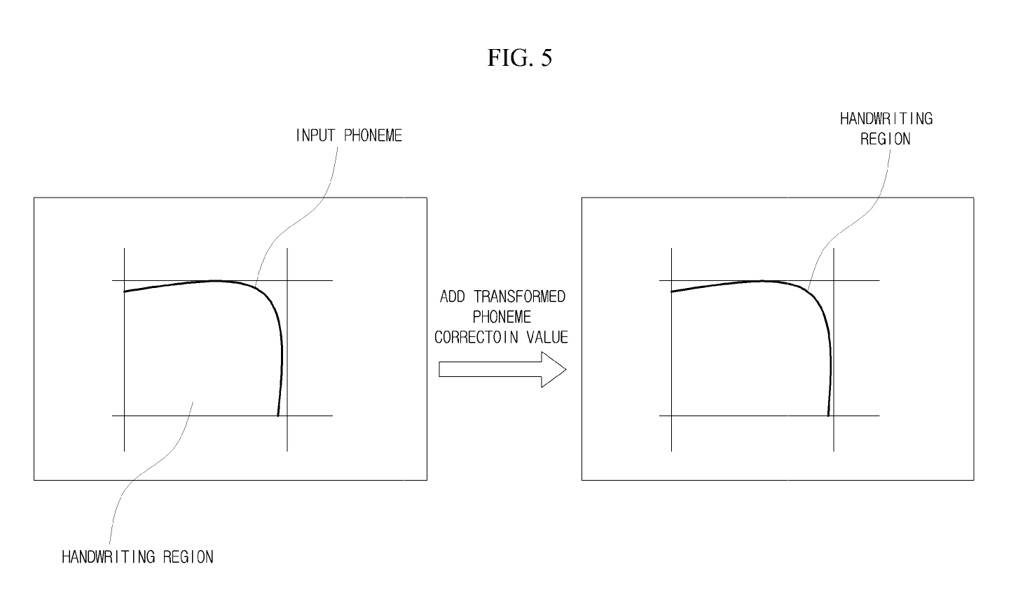

FIG. 5 is a conceptual view illustrating a process of generating a transformed phoneme according to the present invention.

Referring to FIG. 5, the input phoneme analyzing unit 141 calculates a region occupied by a particular input phoneme in the section 2, namely, the area of a handwriting region.

In this case, the area of the handwriting region is obtained by connecting horizontal lines extending from the uppermost portion and the lowermost portion of an input phoneme and vertical lines extending from the leftmost portion and the rightmost portion of the input phoneme. In other words, the area of the handwriting region is an area of the smallest quadrangle including the particular input phoneme in the section 2, namely, which is obtained by calculating a length value and a width value of the quadrangle and multiplying them. In other words, the area of the handwriting region is an area of a quadrangle having intersections of horizontal lines drawn from the uppermost point and the lowermost point of the region in which the input phoneme is input and vertical lines drawn from the rightmost point and the leftmost point of the region in which the input phoneme is input, as vertices.

The resizing unit 142 multiplies a pre-set transformation phoneme correction value (preferably, 0.3 to 0.9) to the area of the handwriting region to transform the size of the input phoneme to thus generate a transformed phoneme, and classifies and stores each transformed phoneme in the transformed phoneme DB.

In this case, the transformation phoneme correction value, as a numerical value to be added with the area of the handwriting region or a width value and a length value required for resizing the input phoneme to derive a transformed phoneme, may be a percent value adjusting the handwriting region of the input phoneme overall or may be different length and width correction values multiplied to each of a length value and a width value to individually change the length and width to change a shape as well as a size.

The transformation phoneme correction values should be differently set according to types of transformation vowels and transformation consonants, and respective transformation phoneme correction values may be previously stored as predetermined values in a system according to the present invention or may be automatically formed according to the area value of the handwriting region or a width value and a length value of the handwriting region. Namely, in a case in which the area value of the handwriting region is greater than a predetermined level, the value of the particular transformation phoneme correction value (for example, third group consonant correction value) is set to 0.7, and in a case in which the area value of the handwriting region is smaller than the predetermined value, the particular transformation phoneme correction value is set to 0.8, whereby the transformation phoneme correction value may be automatically formed according to the area value of the handwriting region.

Also, the transformed phoneme also includes a transformed connection point included in the input phoneme. In other words, as an input phoneme is transformed, a connection point included in the input phoneme is also transformed in the same ratio such that transformed phonemes are naturally combined or in a point-to-point manner.

In addition, the area value of the handwriting region and the transformation phoneme correction value may include numeral values related to a position or curvature of a phoneme, and the like.

The resizing unit 142 may include a correction value input unit. The correction value input unit receives transformation phoneme correction values ranging from 0.3 to 0.9 from the user. After the transformation phoneme correction values are displayed, the user may designate respective correction values (namely, designate correction value numbers), thereby arbitrarily setting the transformation phoneme correction values used by the transforming module 140, whereby shapes of syllables combined by the handwriting combining module 150 may be implemented according to user preference.

In this case, the reason for limiting the input range to 0.3 to 0.9 is because, if value smaller than 0.3 or greater than 0.9 is multiplied to an input phoneme to transform the input phoneme, a handwriting implemented as a transformed phoneme may be ruined too much to be recognized as a general Hangul handwriting.

This may be performed in a manner of receiving by the medium of an input unit (a keyboard, a mouse, a touch screen, and the like) of a user PC or a mobile device.

The aforementioned transforming module 140 may analyze the input phoneme through the foregoing process to calculate an area of the handwriting region, and add a transformation phoneme correction value set for each group to the area value of the handwriting area or the width and length values to generate a transformed phoneme, thus generating various types of transformed phonemes.

Since the transforming module 140 is provided, the system according to the present invention may receive only 59 input phonemes from the user and differentially deforming (resizing) the received input phonemes to generate various groups of transformation phoneme.

The handwriting combining module 150 combines respective phonemes generated through the aforementioned respective modules to generate a unique handwriting style of the user. The handwriting combining module 150 includes a connection point disposing unit 151 and a final consonant syllable generating unit 152.

The connection point disposing unit 151 extracts two or more phonemes required for combining a particular syllable among input phonemes with a connection point designated therein and transformed phonemes and overlaps the connection point in the same position, thus combining phonemes to generate various syllables.

The connection point disposing unit 151 may include a point designating unit.

The point designating unit designates a point at which the connection point is to be positioned in the section 2. Preferably, in case of an open syllable, a portion in which the connection point is disposed, namely, a point in the section 2, is the original position, namely, the position in which the reference connection point 4a is designated, and an initial consonant and a neutral vowel of a closed syllable are disposed to be spaced apart by a predetermined distance upwardly from the original position. In this case, the distance may be set by a system manager or the user.

A process of generating a syllable using a connection point will be described again with reference to FIG. 4. In a case in which “ [symbol] ” is intended to be combined, a syllable may be combined such that “ [symbol] ” (first group consonant) and “ [symbol] ” (first group vowel) of input phonemes may be extracted and disposed such that respective connection points overlap with each other at a particular point of the section 2.

By combining syllables in the connection point corresponding manner, a distance between a consonant and a vowel may be more naturally implemented, based on which only 59 phonemes may be received from the user and a syllable very similar to an actual handwriting of the user may be generated, and thus, a satisfiable handwriting may be generated within a short time.

Here, in a case in which the handwriting combining module 150 generates a closed syllable, a connection point may be designated in a final consonant according to a predetermined reference to combine all of an initial consonant, a neutral vowel, and a final consonant to be combined based on connection points, but more preferably, an initial consonant and a neutral vowel are combined based on a connection point and a final consonant is subsequently disposed in a portion spaced apart by a predetermined distance from the lowermost portion of the neutral vowel. Thus, the handwriting combining module 150 may additionally include a final consonant syllable generating unit 152.

The final consonant syllable generating unit 152 combines a syllable having a final consonant that cannot be easily implemented only through the connection point corresponding scheme. The final consonant syllable generating unit 152 includes a final consonant classifying unit 152a and a final consonant position setting unit 152b, and a final consonant syllable combining unit 152c.

The final consonant classifying unit 152a classifies at least one of consonants of transformed phonemes into a final consonant, and here, preferably, the final consonant is a transformed phoneme transformed based on the second group consonants.

The final consonant position setting unit 152b generates a final consonant position value by designating a distance between an upper end point of the final consonant and a lower end point (preferably, a lower end point of a neutral vowel) of a transformed phoneme to form a syllable with the final consonant, and in this case, the final consonant position value may be previously set by the system manager or designated by the user, and may be designated by pixel or in units of mm.

The final consonant syllable combining unit 152c combines a final consonant in a final consonant syllable using the final consonant position value. Since the final consonant syllable generating unit 152 is included, a closed syllable may also be naturally combined.

Also, the system may further include an exemplifying module 160.

While the user is sequentially inputting input phonemes to implement his or her handwriting with the system according to the present invention, preferably, while input phonemes are being sequentially generated and stored by the input module 130, the exemplifying module 160 may combines a word that may be implemented only with input phonemes generated at a particular point in time and displays the same, thus reducing user boredom and maximizing user satisfaction.

The exemplifying module 160 includes an example handwriting suggesting unit 161 and an example handwriting updating unit 162.

During the process of sequentially generating the input phonemes by the input module 130, when two or more input phonemes are generated, the example handwriting suggesting unit 161 combines them to generate a particular syllable or a particular word to implement an example handwriting and display the same in the section 2.

For example, when a portion of input phonemes is input by the input module 130, the example handwriting suggesting unit 161 may combine a word such as “let's go”, “see”, or the like, that may be implemented only with initially input phonemes (a first group consonant and a second group vowel) and provide the same to the user by the medium of the display unit 1.

After the example handwriting is displayed, when at least one input phoneme is additionally generated by the input module 130, the example handwriting updating unit 162 may combine a different word using the additionally generated input phoneme to update the example handwriting.

As the input phonemes generated by the input module 130 are increased, various words implemented as handwritings of the user may be provided to the user. Thus, since various example handwritings are suggested, the user may estimate a shape, a size, or the like, of an input phoneme that the user is inputting by intuition.

While the user-specific handwriting is being generated by using the system, preferably, the example handwriting updating unit 162 is performed one or more times.

According to the system for generating a unique handwriting style of a user, the user may quickly and simply generate his or her handwriting with 59 input phonemes, and thus, user satisfaction may be maximized, compared to an existing syllable input scheme, or the like.

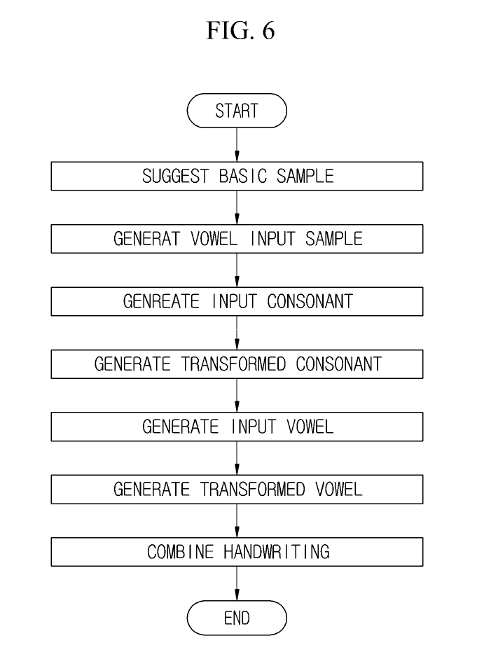

FIG. 6 is a flow chart illustrating a method for generating a handwriting according to the present invention.

A method for generating a handwriting using the system according to the present invention will be described with reference to FIG. 6. The method for generating a handwriting includes an operation of suggesting a basic sample, an operation of generating a vowel input sample 3b, an operation of generating an input consonant, an operation of generating a transformed consonant, an operation of generating an input vowel, an operation of generating a transformed vowel, and an operation of combining a handwriting.

1. Operation of Suggesting Basic Sample

The basic sample generating unit 121 extracts a syllable (preferably, “ [symbol] ” and “ [symbol] ”) having a particular shape from a previously stored font DB to generate a basic sample 3a, and the guide unit 131 displays the basic sample 3a in the section 2 of the screen by the medium of the display unit 1.

2. Operation of Generating Vowel Input Sample

The input phoneme generating unit 132 receives a shape of a vowel (any one of the first group vowels and any one of the second group vowels, preferably, “ [symbol] ” or “ [symbol] ”) guided as the basic sample 3a in a portion in which the basic sample 3a is displayed, as a vowel handwriting of a user handwriting from the user, designates a reference connection point 4a in one end of the vowel handwriting, calculates coordinate values of the corresponding point in the section to generate reference connection point coordinate values, and subsequently stores the vowel handwriting and the reference connection point 4a together as vowel samples.

3. Operation of Generating Input Consonant

The guide unit 131 displays the vowel samples and the input phoneme generating unit 132 receives a shape of a consonant (preferably, a set of consonants (first group consonants) “ [symbol] ”, “ [symbol] ”, “ [symbol] ”, or the like, such as “ [symbol] ”, “ [symbol] ”, “ [symbol] ”, or the like, or a set of consonants (second group consonants) “ [symbol] ”, “ [symbol] ”, “ [symbol] ”, or the like, such as “ [symbol] ”, “ [symbol] ”, “ [symbol] ”, or the like) that may form a syllable together with the vowel samples, as a consonant handwriting of a user handwriting, designates a corresponding connection point of the consonant handwriting in the reference connection point coordinate values in the section, and subsequently stores the consonant handwriting and the corresponding connection point together, as an input consonant.

4. Operation of Generating Transformed Consonant

The transforming module 140 generates different transformed consonants according to sizes and positions of input consonants and classifies and stores them.

The transformed consonants generated in this case are third group to fifth consonants generated based on the second group consonants, an initial consonant or a final consonant of a closed syllable.

5. Operation of Generating Input Vowel

In a state in which the guide unit 131 displays consonant input samples, any one of the input consonant and the transformed consonant, in the section 2, the input phoneme generating unit 132 receives a shape of a vowel forming a syllable together with the consonant input sample, as a vowel handwriting of the user handwriting, from the user, designates a corresponding connection point of the vowel handwriting in a reference connection point position, and subsequently stores the vowel handwriting and the corresponding connection point together, as an input vowel.

Namely, the consonant input samples are composed of one of each of the first to fifth group consonants, and the consonant input samples of the respective groups are displayed, whereby the entire first to fifth vowels may be received.

6. Operation of Generating Transformed Vowel

The transforming module 140 generates different transformed vowels according to sizes and positions of the input vowels and vowel input samples 3b, and classifies and stores the same.

The transformed vowels generated in this case are final vowels of a closed syllable.

7. Operation of Combining Handwriting

The handwriting combining module 150 combines a plurality of syllables by overlapping connection points of each of the vowel input sample 3b and the input vowel, the transformed vowel, and the input consonant and the transformed consonant in particular points of the section 2, generating a unique handwriting style of a user.

The operation of combining a handwriting is divided into an operation of designating a connection point position and an operation of disposing a phoneme.

7-1. Operation of Designating Point

During this operation, the point designating unit designates a point to be positioned in the section. In a case in which a syllable to be combined is an open syllable (in a case in which a syllable is intended to be combined with first to fifth vowels and consonants), the connection point coordinate values are designated as a connection point at which the connection point is to be disposed.

On the other hand, in a case in which a syllable intended to be combined is a closed syllable (namely, in a case in which a syllable is intended to be combined with an initial consonant, a neutral vowel, and a final consonant), connection points of the initial consonant and the neutral vowel are disposed in portions spaced apart by a predetermined gap upwardly from the connection point coordinate values.

This is because, in case of an initial consonant and a neutral vowel of a closed syllable, a space in which a final consonant is disposed needs to be considered, and thus, it should be moved upwards by a predetermined interval within the section 2.

7-2. Operation of Disposing Phoneme

Connection points of respective phonemes to be combined with the connection points designated in operation 7-1 are disposed in an overlapping manner, thus combining a syllable.

The foregoing final consonant syllable generating unit 152 disposes the final consonant in a portion spaced apart by a predetermined distance from a lower end portion of the neutral vowel handwriting.

Phonemes generated during the respective operations of the method for generating a handwriting will be described. Input samples 3b “ [symbol] ” and “ [symbol] ” are generated during the second operation, and first and second group consonants forming a syllable together with input vowels “ [symbol] ” and “ [symbol] ” are input and generated during the third operation.

During a fourth operation, based on the second group consonants, third to fifth consonants, and an initial consonant and a final consonant of a closed syllable are transformed to be generated.

During a fifth operation, all of the first to fifth group vowels are input and generated by five consonant input samples (in this case, “ [symbol] ” and “ [symbol] ” of the input samples 3b may be omitted) by five consonant input samples.

During a sixth operation, all of neutral vowels of a closed syllable are transformed to be generated based on the first to fifth vowels.

Through the first to sixth operations, every phoneme required for combining Hangul syllables may be input to be generated or transformed to be generated, and during a seventh operation, a connection point is set according to an open syllable or a closed syllable, and each connection point given to each phoneme overlaps in a point-to-point manner, thus combining a syllable.

So far, the configuration and operation of the system for generating a unique handwriting style of a user according to the present invention have been described and illustrated in the drawings. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### INDUSTRIAL APPLICABILITY

The present invention can be used in application of smartphone or apparatus linked to display panel (touch-screen), so it has industrial applicability.

1. A system for generating a unique handwriting style of a user, the system comprising:
a region designating module configured to classify divided regions of a screen into a guide region guiding a user input and an input region receiving handwriting data from a user;
an input module including a guide unit configured to display phoneme samples guiding a handwriting input of the user in the guide region and an input phoneme generating unit configured to receive a unique handwriting style of a user from the user with the phoneme samples displayed in the guide unit, and store the same as input phonemes;
a transforming module configured to generate various types of transformed phoneme according to different sizes and positions of respective input phonemes, and classify and store the generated transformed phonemes; and
a handwriting combining module configured to combine the input phonemes and the transformed phonemes to implement a unique handwriting style of the user.

2. The system of claim 1, further comprising:
a basic sample generating unit configured to extract at least one syllable from a previously stored font database (DB) to generate a basic sample; and
a phoneme sample managing module configured to extract at least one input phonemes to generate an input sample,
wherein the phoneme sample displayed by the guide unit is any one of the basic sample and the input sample.

3. The system of claim 2, wherein the section is configured as a plane of coordinates,
the input phoneme generating unit comprises:
a reference connection point designating unit configured to designate a reference connection point in one end portion of the handwriting of the input sample;
a connection point coordinate value extracting unit configured to recognize a position of the reference connection point in the section and generate a reference connection point coordinate value; and
a corresponding connection point designating unit configured to designate a position of the reference connection point coordinate value as a corresponding connection point of the handwriting received from the user, when the guide unit displays the input sample with the reference connection point designated therein, and
the handwriting combining module comprises:
a connection point disposing unit configured to dispose respective connection points in an overlapping manner to combine the input phoneme and the transformed phonemes.

4. The system of claim 1, wherein the transforming module comprises:
an input phoneme analyzing unit configured to calculate a width value and a length value of a handwriting region having a quadrangular shape having intersections of horizontal lines extending from the uppermost point of the input phoneme and the lowermost point of the input phoneme and vertical lines extending from the leftmost point of the input phoneme and the rightmost point of the input phoneme, as vertices; and
a resizing unit configured to multiply different transformation phoneme correction values to the width value and the length value to differently transform the handwriting region to a plurality of sizes and classify and store the same as transformed phonemes.

5. The system of claim 1, wherein the handwriting combining module further comprises:
a final consonant syllable generating unit comprising:
a final consonant classifying unit configured to classify at least one of consonants of the transformed phonemes to a final consonant;
a final consonant position setting unit configured to set a distance between an upper end point of the final consonant and a lower end point of a transformed phoneme to form a syllable with the final consonant to generate a final consonant position value; and
a final consonant syllable combining unit configured to combine a final consonant in a final consonant syllable using the final consonant position value.

6. The system of claim 1, further comprising:
an example handwriting suggesting unit configured to combine two or more generated input phonemes to implement an example handwriting and display the example handwriting in a portion of the section other than the guide region and the input region; and
an exemplifying module configured to, when the input phoneme is additionally generated after the example handwriting is displayed, update the example handwriting to a different word using the additionally generated input phoneme.

7. A method for generating a unique handwriting style of a user, the method comprising:
a basic sample suggesting operation of displaying basic samples as syllable shapes of previously stored handwritings in a section of a screen by the medium of a display unit;
a vowel sample generating operation of receiving a vowel handwriting of a user handwriting from a user in a portion where the basic samples are displayed, designating a reference connection point in one end of the vowel handwriting, calculating a coordinate value of the corresponding point in the section to generate a reference connection point coordinate value, and subsequently storing the vowel handwriting and the reference connection point together, as a vowel sample;
an input consonant generating operation of receiving a shape of a consonant that may form a syllable together with the vowel input sample, as a consonant handwriting of the user handwriting from the user in a state in which the vowel input sample is displayed in the section, designating a corresponding connection point of the consonant handwriting at the reference connection point coordinate value in the section, and subsequently storing the consonant handwriting and the corresponding connection point together, as an input consonant;
a transformed consonant generating operation of generating transformed consonants according to different sizes and positions of the input consonant, and classifying and storing the same;
a vowel handwriting input operation of receiving a shape of a vowel forming a syllable together with the consonant input sample, as a vowel handwriting of the user handwriting from the user in a state in which a consonant input sample, any one of the input consonant and the transformed consonant, is displayed in the section, designating a corresponding connection point of the vowel handwriting at the reference connection point position, and subsequently storing the vowel handwriting and the corresponding connection point together as an input vowel; a transformed vowel generating operation of generating transformed vowels according to different sizes and positions of the input vowel and the vowel input samples, and classifying and storing the same; and
a handwriting combining operation of disposing connection points of each of the vowel input samples and the input vowel, the transformed vowel and the input consonant, and the transformed consonant in a particular point in an overlapping manner within the section to combine a plurality of syllables to generate a unique handwriting style of the user.

8. The method of claim 7, wherein the handwriting combining operation comprises:
a point designating operation of designating the reference connection point coordinate value as a connection point when a syllable to be combined is an open syllable, and designating a connection point in a portion spaced apart from the reference connection point coordinate value by a predetermined distance upwardly when a syllable to be combined is a closed syllable; and
a phoneme disposing operation of disposing connection points of each phoneme at the connection point in an overlapping manner.
